(19) United States
(12) Patent Application Publication
(10) Pub. No.: US 2001/0044933 A1
(43) Pub. Date: Nov. 22, 2001

(54) SYSTEM FOR VERSION-UP OF A FIRMWARE STORED IN A REPRODUCING SYSTEM FOR AN INFORMATION RECORDING MEDIUM

(76) Inventors: TAKAO TAGIRI, YAMANASHI-KEN (JP); YOSHIHISA NAGAI, YAMANASHI-KEN (JP)

Correspondence Address: ARENT FOX KINTNER PLOTKIN AND KAHN PLLC, 1050 CONNECTICUIT AVENUE, N.W., SUITE 600, WASHINGTON, DC, 20036-5339, US

(21) Appl. No.: 09/098,753

(22) Filed: Jun. 17, 1998

(30) Foreign Application Priority Data
Jun. 23, 1997 (JP) 9-181685

(51) Int. Cl. G06F 9/44

(52) U.S. Cl. 717/11

(57) ABSTRACT

It is determined that an optical disc reproduced in a reproducing system has version-up data. In response to the determination, it is determined the necessity of updating firmware stored in the reproducing system. In response to the determination of existence of the version-up data and the necessity of updating, the firmware stored in the reproducing system is changed with the version-up data recorded on the optical disc.

### BACKGROUND OF THE INVENTION

The present invention relates to a method for improving a firmware in a reproducing system for an optical disc.

In the optical disc reproducing system, there is provided a rewritable storage such as EEPROM (Electronically Erasable and Programmable Read Only Memory) which stores a firmware for operating the reproducing system.

There occurs the case that an old firmware having a low operability must undergo a process for version-up. In order to perform the version-up, the ROM storing the firmware is exchanged with another ROM, or the firmware in the ROM is written by an exclusive device. However, it is difficult to carry out such an operation for an ordinary person other than operators skilled in the operation. In addition, a long time and trouble are required.

### SUMMARY OF THE INVENTION

An object of the present invention is to provide a method which may perform version-up of a firmware with ease.

According to the present invention, there is provided a system for updating a firmware stored in a reproducing system for an optical disc, comprising, first determining means for determining that an optical disc reproduced in the reproducing system has version-up data recorded on the optical disc, and for producing a version-up signal, second determining means for determining that it is necessary to update the firmware stored in the reproducing system, and for producing an updating signal, means responsive to the version-up signal and the updating signal for changing the firmware stored in the reproducing system with the version-up data recorded on the optical disc.

The first determining means determines the existence of the version-up data by reproducing the optical disc by the reproducing system.

The second determining means determines the necessity of the updating by reading the firmware stored in the reproducing system.

These and other objects and features of the present invention will become more apparent from the following detailed description with reference to the accompanying drawings.

### BRIEF DESCRIPTION OF DRAWINGS

FIG. 1 is a block diagram of a reproducing system for an optical disc to which the present invention is applied; and

FIG. 2 is a flowchart of the method of the present invention.

### DETAILED DESCRIPTION OF THE PREFERRED EMBODIMENT

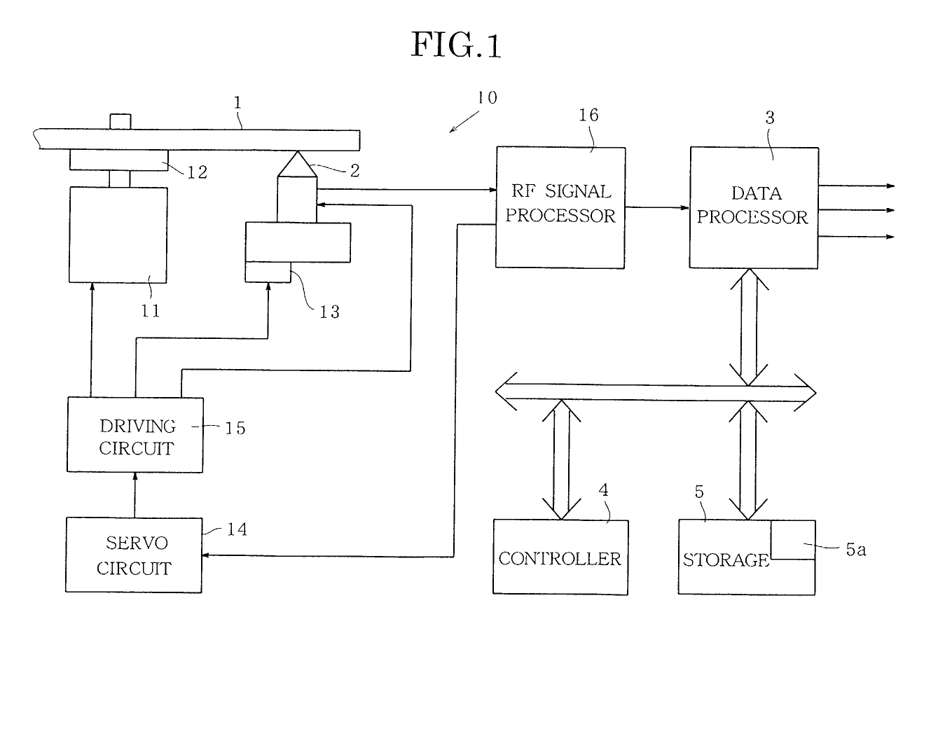

Referring to FIG. 1 showing an optical disc reproducing system, an optical disc is securely mounted on a turntable 12 which is to be rotated by a spindle motor 11. An optical pickup 2 is disposed underside the disc 1 and radially moved by a feed motor 13.

The spindle motor 11, feed motor 13 and pickup 2 are controlled by a servo circuit 14 and a driving circuit 15 under the control of a microprocessor.

Data read out by the pickup 2 are fed to an RF signal processor 16. The RF signal processor 16 includes an RF amplifier, servo error amplifier and others for producing focus error and tracking error signals which are applied to the servo circuit 14. The RF signal processor 16 also produces modulated data which is fed to a data processor 3.

The data processor 3 includes a demodulator, PLL circuit, error correction circuit and others for producing processed image data, audio data, digital data, and program data.

The data processor 3 is connected to a controller 4 and a storage 5, which composes the microprocessor through bus.

The controller 4 controls operations of the pickup 2, the data processor 3 and all other devices.

In the storage 5, a rewritable ROM 5a storing a firmware is provided. The rewritable ROM is, for example, EEPROM. The controller 4 performs the above described control by executing the firmware stored in the rewritable ROM 5a.

In the ROM 5a, a software program is stored for erasing the stored firmware and for writing a new firmware.

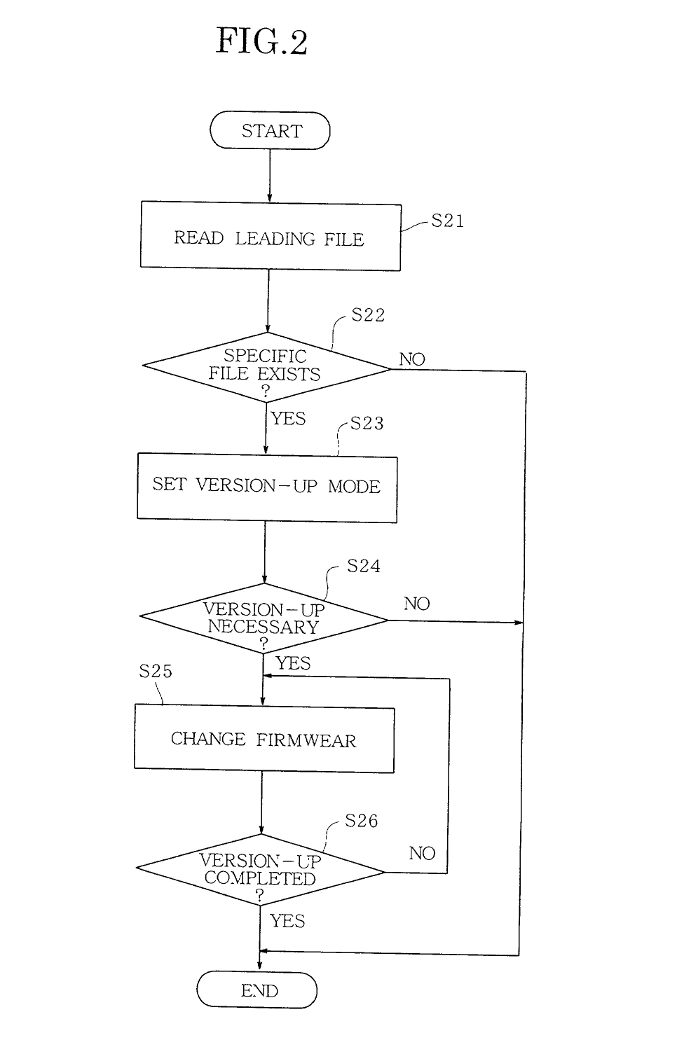

FIG. 2 shows a flowchart for writing a new firmware in the ROM 5a.

When the reproduction of an optical disc mounted on the turntable 12 is started, a leading file is read at a step S21, so that information for the content of the disc, the kind of data to be reproduced, and others recorded in the lead-in area of the disc are determined.

At a step S22, it is determined whether there is a specific file having a version-up data in the disc. For example, an ordinary audio disc has not such a specific file. In such a case, the program is ended.

If the disc has a specific file having a version-up data, a version-up mode is set at a step S23.

At a step 24, the controller 4 reads the ROM 5a, and it is determined whether the firmware stored in the ROM 5a has already been updated. If the firmware is updated, the program is ended.

If not, the controller 4 operates to erase the firmware in the ROM 5a and to write the version-up data recorded on the disc 1 in the ROM 5a. The version-up operation is repeated and when the operation is completed (step S26), the program is ended.

Meanwhile, the version-up data includes data representing the version of the firmware for checking the version at the updating.

From the foregoing it will be understood that the present invention provides a system for automatically updating the firmware stored in a rewritable ROM. Therefore, even the user can update the firmware in the reproducing device.

While the invention has been described in conjunction with preferred specific embodiment thereof, it will be understood that this description is intended to illustrate and not limit the scope of the invention, which is defined by the following claims.

What is claimed is:

1. A system for updating a firmware stored in a reproducing system for an optical disc, comprising:
first determining means for determining that an optical disc reproduced in the reproducing system has version-up data recorded on the optical disc, and for producing a version-up signal;
second determining means for determining that it is necessary to update the firmware stored in the reproducing system, and for producing an updating signal;
means responsive to the version-up signal and the updating signal for changing the firmware stored in the reproducing system with the version-up data recorded on the optical disc.

2. The system according to claim 1 wherein the first determining means determines the existence of the version-up data by reproducing the optical disc by the reproducing system.

3. The system according to claim 1 wherein the second determining means determines the necessity of the updating by reading the firmware stored in the reproducing system.
